(19) United States
(12) Patent Application Publication
(10) Pub. No.: US 2025/0271255 A1
(43) Pub. Date: Aug. 28, 2025

(54) ALIGNMENT SUBSTRATE FOR SMART CARD CHIP PROGRAMMER CONTACT PINS

(71) Applicant: Entrust Corporation, Shakopee, MN (US)

(72) Inventors: JON WAWRA, Shakopee, MN (US); RYAN BOUDREAU, Shakopee, MN (US); TAHA NAJMEE, Shakopee, MN (US); JEFF AYMOND, Shakopee, MN (US)

(21) Appl. No.: 19/041,695

(22) Filed: Jan. 30, 2025

Related U.S. Application Data
(60) Provisional application No. 63/558,279, filed on Feb. 27, 2024.

(51) Int. Cl. G01B 11/27

(52) U.S. Cl. CPC G01B 11/27

(57) ABSTRACT

An alignment substrate that contains a test chip connected to contact pads, as well as alignment features, is positioned relative to a chip programming head. When the alignment substrate and the chip programming head are actuated toward one another so that the contact pins are near or in contact with the contact pads, the alignment features allow a user to visually verify that the contact pins are on the same alignment plane as the alignment substrate, and therefore on the same alignment plane as a card with a programmable chip to be programmed.

### FIELD

This technical disclosure relates to programming integrated circuit chips on cards (which are sometimes referred to as smart cards or chip cards) such as financial cards (for example credit and debit cards), identification cards, and other personalized cards.

### BACKGROUND

To program a contact-type integrated circuit chip (or just programmable chip) on a card, contact pins on a chip programming head of a chip programmer must be properly aligned with, and brought into engagement with, electrical contacts on the programmable chip. If the contact pins are not properly aligned with the electrical contacts, communication between the programmable chip and the chip programming head may not be established. If there is misalignment, the position of the contact pins is adjusted, for example by adjusting the chip programming head, to bring the contact pins into alignment with the electrical contacts.

### SUMMARY

A technique is described herein that simplifies the process of aligning the contact pins of a chip programming head to ensure proper alignment with the electrical contacts on a programmable chip of a card. An alignment substrate that contains a test chip connected to contact pads, as well as alignment features, is positioned relative to the chip programming head. When the alignment substrate and the chip programming head are actuated toward one another so that the contact pins are near or in contact with the contact pads on the test chip, the alignment features allow a user to visually verify that the contact pins are on the same alignment plane as the alignment substrate, and therefore on the same alignment plane as a card with a programmable chip to be programmed. In an embodiment, it may be possible to configure the alignment substrate so that the alignment substrate does not have the alignment features.

If the contact pins are not on the same alignment plane as the alignment substrate, the position of the contact pins can be adjusted while the alignment substrate is still in position so that the alignment features can be used to visually verify alignment as the position of the contact pins is being adjusted. Once alignment is achieved, the alignment substrate can be removed and a card with a programmable chip to be programmed can then be brought into position for engagement by the contact pins of the chip programming head. The programmable chip may then be reset by the chip programming head to make sure communication is possible and/or the programmable chip may be programmed.

The alignment substrate can have any configuration that is suitable to allow it to be used in card personalization systems. In an embodiment, the alignment substrate may be configured as a card-shaped substrate, which case the alignment substrate may also be referred to as an alignment card. In the case of a card-shaped substrate, the substrate is configured to allow it to be transported by the card transport mechanism(s) of the card personalization system. For example, the card-shaped substrate may have a size that is similar or identical to cards that are normally handled by card personalization systems. For example, the card-shaped substrate may be shaped and sized like an ID-1 card as defined by ISO/IEC 7810, or shaped and sized like an ID-2 card as defined by ISO/IEC 7810.

In one embodiment of the alignment substrate, the alignment substrate can include a card-shaped substrate having a first surface, a second surface opposite the first surface, and a perimeter edge. A test chip is provided on the card-shaped substrate, and the test chip is connected to contact pads that are exposed at the first surface or at the second surface. In addition, alignment indicators may be provided on the first surface or on the second surface that intersect the contact pads.

In another embodiment of the alignment substrate, the alignment substrate can include a substrate having a first surface, a second surface opposite the first surface, first and second side edges, and first and second end edges. A programmable test chip is provided on the substrate, with the programmable test chip electrically connected to electrical contact pads that are exposed at the first surface or at the second surface. In addition, alignment lines that are visible to the naked eye and that intersect the electrical contact pads may be provided on the first surface or on the second surface.

In another embodiment, a method of aligning contact pins of a chip programming head for programming a programmable chip on a card-shaped substrate can include positioning the alignment substrate under the chip programming head. The chip programming head and the alignment substrate are then brought toward each other until the contact pins are near or in contact with the electrical contact pads. It is then determined whether the contact pins are aligned with the electrical contact pads. If the contact pins are not aligned with the electrical contact pads, the position of the contact pins is adjusted until the contact pins are aligned with the electrical contact pads. Thereafter, the alignment substrate is removed and the card-shaped substrate is transported to a position under the chip programming head and the contact pins of the chip programming head are used to communicate with the programmable chip on the card-shaped substrate.

In another embodiment, an alignment card can include a card-shaped substrate having a first surface, a second surface opposite the first surface, and a perimeter edge. In addition, a programmable test chip is on the card-shaped substrate, with the programmable test chip electrically connected to electrical contact pads that are exposed on the card-shaped substrate.

In an embodiment, the alignment substrate may not have a card shape and instead may have a shape that is similar or identical to another type of personalized document having a programmable chip thereon. In this situation, the alignment substrate may have the features, including the test chip and alignment indicators, of the card-shaped alignment substrate described herein. For example, a passport may include a programmable chip, in which case the alignment substrate may have the shape and size of a passport or of a page of the passport on which the programmable chip is mounted.

### DRAWINGS

FIG. 1 illustrates a surface of an alignment substrate in the form of a card-shaped substrate described herein.

FIG. 2A schematically depicts a chip programming head.

FIG. 2B is a side view of the chip programming head of FIG. 2A.

FIG. 3 schematically depicts an example of a card personalization system that can utilize the alignment substrate described herein.

FIG. 4 schematically depicts another example of a card personalization system that can utilize the alignment substrate described herein.

FIG. 5A illustrates a first surface of a card with a programmable chip that can be programmed.

FIG. 5B illustrates a second surface of the card of FIG. 5A.

FIG. 6 illustrates a method of aligning contact pins of a chip programming head.

### DETAILED DESCRIPTION

The following is a detailed description of techniques that simplify the process of aligning the contact pins of a chip programming head to ensure proper alignment with the electrical contact pads of a programmable chip of a card. As described in further detail below, an alignment substrate that contains a test chip electrically connected to contact pads, and optional alignment features, is positioned relative to the chip programming head. The alignment substrate may be considered planar or substantially planar, as well as rigid or substantially rigid. When the alignment substrate and the chip programming head are actuated toward one another so that the contact pins are near or in contact with the contact pads on the test chip, the alignment features allow a user to visually verify that the contact pins are on the same alignment plane as the alignment substrate, and therefore on the same alignment plane as a card with a programmable chip to be programmed. If the contact pins are not on the same alignment plane as the alignment substrate, the position of the contact pins can be adjusted while the alignment substrate is still in position so that the alignment features can be used to visually verify alignment as the position of the contact pins is being adjusted. Once alignment is achieved, the alignment substrate can be removed and a card with a programmable chip to be programmed can then be brought into position for engagement by the contact pins of the chip programming head. The programmable chip may then be reset by the chip programming head to make sure communication is possible and/or the programmable chip may be programmed.

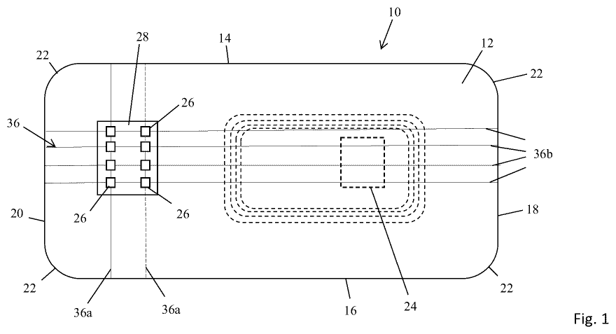

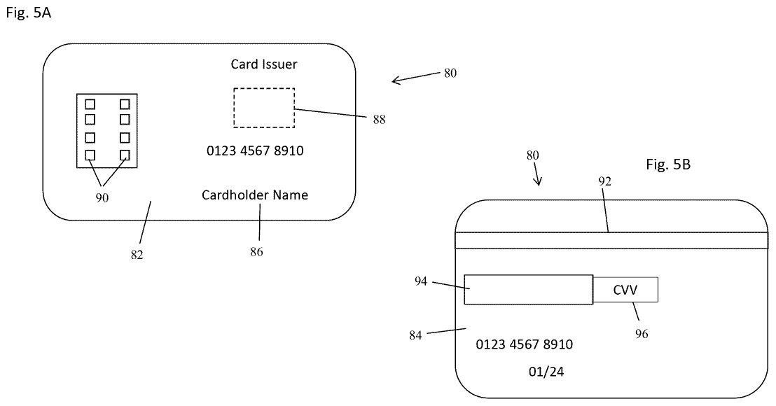

FIG. 1 illustrates an example of an alignment substrate 10. In this example, the alignment substrate is depicted as being card-shaped in which case the alignment substrate 10 may also be referred to as an alignment card. Card-shaped refers to a structure having a first surface 12, a second surface (not shown but generally similar to the second surface of the card shown in FIG. 5B) opposite the first surface 12, a first side edge 14, a second side edge 16, a first end edge 18, a second end edge 20, and rounded corners 22. The alignment substrate 10 can have any configuration that is suitable to allow it to be used in card personalization systems and to be transported by the card transport mechanism(s) of the card personalization system. For example, the alignment substrate 10 may have a size that is similar or identical to cards that are normally handled by card personalization systems. For example, the alignment substrate 10 may be shaped and sized like an ID-1 card as defined by ISO/IEC 7810, or shaped and sized like an ID-2 card as defined by ISO/IEC 7810. In one embodiment, the card can be sized to comply with ISO/IEC 7810 with dimensions of about 85.60 by about 53.98 millimeters (about 3⅜ in x about 2⅛ in) and rounded corners 22 with a radius of about 2.88-3.48 mm (about ⅛ in).

The alignment substrate 10 may be made of any material that allows the alignment substrate to perform its functions described herein. For example, the alignment substrate 10 can be formed entirely or predominantly of a material such as plastic, or formed of a combination of materials such as plastic and non-plastic materials, or formed entirely or predominantly of metal. The alignment substrate 10 may also be formed of materials used to fabricate printed circuit boards, such as a composite of epoxy resin and woven fiberglass. In an embodiment, the alignment substrate 10 may be planar or substantially planar, and rigid or substantially rigid.

With continued reference to FIG. 1, a test chip 24 is disposed on the substrate 10. The test chip 24 may be partially or fully embedded in the substrate 10. The test chip 24 is electrically connected to contact pads 26 on a substrate 28. A surface of the substrate 28 is exposed in the illustrated example at the first surface 12 so that the contact pads 26 are exposed at the first surface 12. Alternatively, the surface of the substrate 28 with the contact pads 26 may be exposed at the second surface of the substrate 10. In an embodiment, the exposed surface of the substrate 28 may be flush with the first surface 12. The illustrated example depicts eight of the contact pads 26 although a larger or smaller number of the contact pads 26 can be provided. In an embodiment, the contact pads 26 may be non-functional and simply provide a reference location for aligning with contact pins on an alignment head during the alignment process. In another embodiment, the test chip 24 may be programmable in which case the contact pads 26 may be electrical contacts that allow data, such as commands, to be input to the test chip 24 or output from the test chip 24. The size of the test chip 24 on the substrate 10 may have a size that corresponds to a conventional chip on a conventional card. The contact pads 26 may have a size that corresponds to conventional contact pads on a conventional card, or the contact pads 26 may be undersized relative to conventional contact pads to make the alignment substrate 10 more sensitive for the calibration. Once contact is made between the contact pins and the contact pads 26, the coupler can reset the chip 24 to make sure communication is possible and verify the position with the contact connections.

The alignment substrate 10 may further include a plurality of alignment indicators 36 on the first surface 12 (or on the second surface if the contact pads are exposed at the second surface), for example as depicted in FIG. 1. The alignment indicators 36 are provided to allow a user to visually verify that the contact pins of the programming head are on the same alignment plane as the alignment substrate 10, and therefore on the same alignment plane as a card with a programmable chip to be programmed. The alignment indicators 36 are positioned on the first surface 12 to allow such visual verification.

For example, in FIG. 1, the alignment indicators 36 are depicted as intersecting the contact pads 26. The alignment indicators 36 are depicted as including vertical alignment indicators 36a and horizontal alignment indicators 36b. Two of the vertical alignment indicators 36a are depicted although a smaller or larger number of the vertical alignment indicators 36a can be provided depending upon the number and arrangement of the contact pads 26. Four of the horizontal alignment indicators 36b are depicted although a smaller or larger number of the horizontal alignment indicators 36b can be provided depending upon the number and arrangement of the contact pads 26.

The vertical alignment indicators 36a can be parallel to the first and second end edges 18, 20. In an embodiment, the vertical alignment indicators 36a extend from both the first side edge 14 and the second side edge 16, and may also extend through the contact pads 26 that are arranged into two columns in the illustrated example. The horizontal alignment indicators 36b can be parallel to the first and second side edges 14, 16. In an embodiment, the horizontal alignment indicators 36b extend from both the first end edge 18 and the second end edge 20, and may extend through the contact pads 26 arranged into four rows in the illustrated example. The alignment indicators 36a, 36b can take any form suitable for indicating alignment. For example, the alignment indicators 36a, 36b may comprise alignment lines that are visible to the naked eye (i.e. able to be seen without special equipment such as a magnifying glass, microscope, loop, etc.). The alignment indicators 36a, 36b may be solid lines, broken lines, combinations thereof, or other indicators suitable for indicating alignment. In another embodiment, the alignment indicators 36a, 36b could be formed such that they are only visible under special lighting conditions, such as when illuminated by infrared or ultraviolet radiation.

As described in further detail below, the alignment substrate 10 is configured to allow it to be transported by a card transport mechanism(s) of a card personalization system to be brought into position during an alignment process for aligning contact pins of a chip programming head. The alignment substrate 10 may be manually inserted into and ultimately manually removed from the card personalization system. Alternatively, the alignment substrate 10 may be mechanically inserted into and ultimately mechanically removed from the card personalization system. For example, in the case where the alignment substrate 10 is card-shaped, the substrate 10 may initially reside in a feed hopper and then is fed from the hopper and mechanically transported into position relative to the chip programming head. In an embodiment, when properly positioned relative to the chip programming head during the alignment process, the alignment substrate 10 may lay flat with the first surface 12 facing upward and with the chip programming head above the substrate 10. However, the substrate 10 and the chip programming head can have any positions relative to one another during the alignment process. For example, the alignment substrate may be arranged vertically in a vertical plane with the first surface 12 facing forward or rearward.

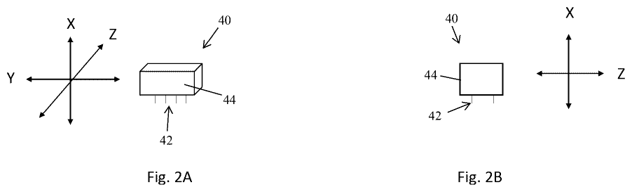

Referring to FIGS. 2A and 2B, a schematic depiction of a chip programming head 40 is provided. The general construction and operation of a chip programming head is well known in the art. The chip programming head 40 includes a plurality of contact pins 42 mounted on a support 44 that, when properly aligned, are configured and positioned to contact electrical contact pads on a programmable chip of a card. In an embodiment, the support 44, and therefore the contact pins 42 themselves, may be actuatable along X, Y, Z axes relative to the alignment substrate during an alignment process to properly align the contact pins 42 with the contact pads on the alignment card. In an embodiment, the support 44 can be stationary and the contacts pins 42 can be adjusted along the X, Y, Z axes relative to the support 44 to achieve alignment. In another embodiment, the alignment substrate may be actuatable along X, Y, Z axes relative to the chip programming head 40 during an alignment process to properly align the contact pads of the alignment substrate with the contact pins 42. In another embodiment, both the chip programming head 40 and the alignment substrate may be adjustable along X, Y, Z axes to achieve alignment.

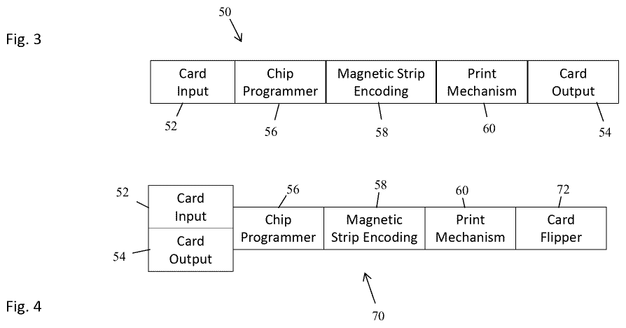

FIG. 3 illustrates an example of a card personalization system 50 in which the alignment substrate described herein can be implemented. The system 50 is configured as a large volume batch production card personalization system (sometimes referred to as a central issuance personalization system). A large volume batch production card personalization system is configured to process multiple cards at the same time, with the cards being processed in sequence, with the cards proceeding generally along a card transport direction/transport path. A large volume batch production card personalization system typically processes cards in high volumes, for example on the order of high hundreds or thousands per hour, and employs multiple processing stations or modules to process multiple cards at the same time to reduce the overall per card processing time. Examples of such large volume card personalization machines include the MX and MPR family of central issuance personalization machines available from Entrust Corporation of Shakopee, Minnesota. Other examples of central issuance personalization machines are disclosed in U.S. Pat. Nos. 4,825,054, 5,266,781, 6,783,067, 6,902,107, and 10,049,320 all of which are incorporated herein by reference in their entirety.

In the system 50 illustrated in FIG. 3, a card input 52 is provided that is configured to hold a plurality of cards waiting to be processed. Cards are fed one-by-one from the card input 52 into the rest of the system 50 where each card is individually processed. Processed cards are transported into a card output 54 that is configured to hold a plurality of the processed cards. The system 50 is further depicted as including a chip programmer 56 (or chip programming module or chip programming station) that includes the chip programming head described above. The chip programmer 56 may include a single chip programming head for programming a single card at a time. Alternatively, the chip programmer 56 may include a plurality of chip programming heads for simultaneous programming of a plurality of cards. The system 50 is further depicted as including an optional magnetic strip encoder 58 (or a magnetic strip read/write system or magnetic strip module) that is configured to read data from and/or encode data on a magnetic strip on the cards. The system 50 may further include a print mechanism 60 (or print station or print module). The print mechanism 60 may print using any printing technique used in card personalization systems including but not limited to, drop-on-demand printing using an ink such as an ultraviolet (UV) radiation curable ink; retransfer printing; or thermal printing using a print ribbon and a thermal print head. If the print mechanism prints using UV curable ink, a UV cure station can also be provided. Operation of the various systems 52-60 is controlled by one or more controllers. Alternatively, each one of the systems 52-60, or select ones of the systems 52-60, can have its own dedicated controller. Magnetic strip encoding systems and chip programmers are disclosed, for example, in U.S. Pat. Nos. 6,902,107 and 6,695,205, and can be found in the MX™ and MPR™ family of central issuance systems available from Entrust Corporation of Shakopee, Minnesota. An example of a UV cure station is the UV cure station used in the MX™ family of card issuance systems available from Entrust Corporation of Shakopee, Minnesota.

FIG. 4 illustrates another example of a card personalization system 70 in which the alignment substrate described herein can be implemented. In FIG. 4, elements that are the same or similar to elements in FIG. 3 are referenced using the same reference numerals. The system 70 is depicted as being configured as a desktop card personalization system. A desktop card personalization system is typically designed for relatively smaller scale, individual card personalization in relatively small volumes, for example measured in tens or low hundreds per hour, often times with a single card being processed at any one time. These card personalization machines are often termed desktop personalization machines because they have a relatively small footprint intended to permit the machine to reside on a desktop. Many examples of desktop card personalization machines are known, such as the SIGMA™ and ARTISTA™ family of desktop card printers available from Entrust Corporation of Shakopee, Minnesota. Other examples of desktop card personalization machines are disclosed in U.S. Pat. Nos. 7,434,728 and 7,398,972, each of which is incorporated herein by reference in its entirety.

In FIG. 4, the card input 52 and the card output 54 are depicted as being located at the same end of the system 70. However, the card input 52 and the card output 54 may have other relative positions in the system 70 that are found in other desktop card personalization systems. The system 70 may also include a card flipper 72 that is configured to flip a card 180 degrees after being printed in the print mechanism 60 with the card then being directed back into the print mechanism 60 for two-sided or duplex printing on the card.

The cards can be transported through the card personalization systems 50, 70 using any suitable mechanical card transport mechanism(s) that are well known in the art. Examples of card transport mechanisms that could be used are known in the art and include, but are not limited to, transport rollers, transport belts (with tabs and/or without tabs), vacuum transport mechanisms, transport carriages, and the like and combinations thereof. Card transport mechanisms are well known in the art. A person of ordinary skill in the art would readily understand the type(s) of card transport mechanisms that could be used, as well as the construction and operation of such card transport mechanisms.

The systems 50, 70 may include additional card personalization systems not illustrated in FIGS. 3-4, which are well known in the art of card processing. For example, the systems 50, 70 may include a card embossing system that is configured to emboss characters on the cards; an indenting system that is configured to indent characters on the cards; a laminator system that is configured to apply a laminate to the cards; a laser system that uses a laser to perform laser processing such as laser marking on the cards; a topcoat station that is configured to apply a topcoat to a portion of or the entire surface of the cards; a quality control station that is configured to check the quality of personalization/processing applied to the cards; a security station that is configured to apply a security feature such as a holographic foil patch to the cards; and other card processing operations. The additional card personalization systems may be located anywhere in the systems 50, 70.

Referring to FIGS. 1 and 3-4, the alignment substrate 10 may be manually input into the systems 50, 70 during an alignment process. For example, the substrate 10 may be manually input into the system via the card input 52 and then transported into position in the chip programmer 56, or the substrate 10 may be manually input directly into the chip programmer 56. Alternatively, the substrate 10 may be mechanically fed from the input 52 and then transported into position in the chip programmer 56. After the alignment process using the alignment substrate is complete, the substrate 10 may be removed, for example manually, or mechanically transported to the output 54 and then removed. Once the chip programming head is aligned, the card personalization system can then be used to personalize cards.

FIGS. 5A and 5B illustrate an example construction of a card 80 that can be processed using the card personalization system once the chip programming head is aligned. In this example, the card 80 is shown to include a front or first surface 82 (FIG. 5A) and a rear, back or second surface 84 (FIG. 5B) opposite the front surface 82. The card 80 may be printed on one side only (referred to as simplex printing), for example on the front surface 82 or the rear surface 84, or printed on both sides (referred to as duplex printing), for example on each of the front surface 82 and the rear surface 84.

Many possible layouts for the front surface 82 are possible. For example, the front surface 82 can include a horizontal card layout, a vertical card layout, and other known layout configurations and orientations. In the illustrated example in FIG. 5A, the front surface 82 can include various printed cardholder data such as a printed portrait image, the cardholder name 86, and account information such as account number, expiration date and the like. The front surface 82 can also include other printed data such as printed information of the entity that issued the card 80, such as the corporate name and/or logo of the issuing bank (for example, STATE BANK), and/or printed information of the card brand name (for example, VISA®, MASTERCARD®, DISCOVER®, etc.). The card 80 may also include a programmable contact integrated circuit chip 88 that can store various data relating to the card 80 such as an account number and/or name of the cardholder. The chip 88 is electrically connected to a plurality of electrical contact pads 90 exposed at the surface 82 that are engaged by the contact pins of the chip programming head of the chip programmer to communicate with the chip 88, for example to reset the chip and/or to program the chip 88.

Referring to FIG. 5B, many possible layouts for the rear surface 84 are possible which may or may not have a similar layout as the front surface 82. For example, the rear surface 84 can include a horizontal card layout, a vertical card layout, and other known layout configurations and orientations. In the illustrated example in FIG. 5B, the rear surface 84 can include a magnetic strip 92 that stores various data relating to the card 80 such as an account number or name of the cardholder, a signature panel 94 that provides a place for the cardholder to sign their name, a Card Verification Value (CVV) panel 96, and a hologram. The magnetic strip 92, the signature panel 94, the CVV panel 96 and the hologram are conventional elements found on many cards. The rear surface 84 can also include printed personal data that is unique to or assigned specifically to the cardholder. For example, an account number assigned to the cardholder, the name of the cardholder, and a card expiration date can be printed on the rear surface 84. Other personal cardholder data may also be printed on the rear surface 84, such as an image of the face of the cardholder. Non-personal data such as the name of the issuing bank, contact information to contact the issuing bank, and the like, can also be printed on the rear surface 84.

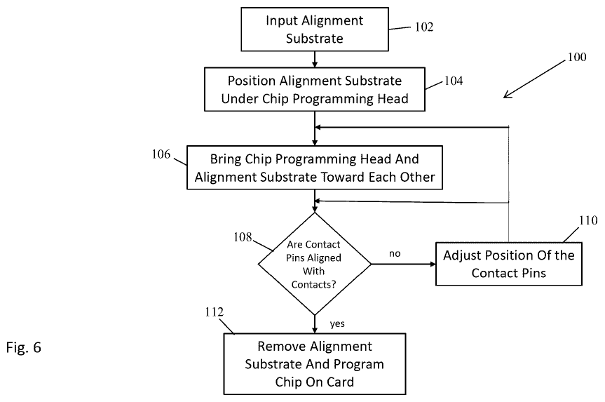

FIG. 6 illustrates a method 100 of aligning contact pins of a chip programming head. Unless indicated by the Applicant to the contrary, the word “step” is intended to cover a single act or action, or a plurality of acts or actions that form the step. Referring to FIG. 6 together with FIGS. 1, 2A-2B, 3 and 4, in step 102 the alignment substrate 10 is input into the system. The alignment substrate 10 may be manually input into the system or mechanically input into the system for example by being fed from the card input 52 of the system. The alignment substrate 10 may be input upstream (or downstream) of the chip programmer 56 and then transported into the chip programmer 56 using the transport mechanisms of the system. Alternatively, the alignment substrate 10 may be input directly into the chip programmer 56.

In step 104, once in the chip programmer 56, the alignment substrate 10 is then positioned under the chip programming head 40 to a programming position which corresponds to the expected location where a card to be programmed would be located with the contact pads facing upward. This positioning assumes that the chip programming head 40 is located vertically above the programming position. Alternatively, if the card is oriented in the chip programmer 56 at the programming position so that the contact pads face downward or sideways, the chip programming head may be located below or to the side of the programming position.

In step 106, the chip programming head 40 and the alignment substrate 10 are then brought toward one another. In an embodiment, the chip programming head 40 is actuated toward the alignment substrate 10 which remains fixed or stationary. In another embodiment, the alignment substrate 10 is actuated toward the chip programming head 40 which remains fixed or stationary. In another embodiment, both the alignment substrate 10 and the chip programming head 40 are movable toward one another. The chip programming head 40 and the alignment substrate 10 are brought toward one another until the contact pins 42 are near, substantially close to, or in actual physical contact with the contact pads 26 of the alignment substrate 10. The contact pins 42 and the contact pads 26 should be close enough to one another so that the user can use the alignment features 36 to visually verify that the contact pins 42 are on the same alignment plane as the alignment substrate 10, and therefore on the same alignment plane as a card with a programmable chip to be programmed.

In step 108, the user uses the alignment features 36 to visually verify that the contact pins 42 are on the same alignment plane as the alignment substrate 10, and therefore that the contact pins are aligned with the contact pads 26. For example, the user can visually ascertain that the contact pins 42 are touching the contact pads 26 of the alignment substrate 10 and/or user can view the alignment indicators 36a, 36b to make it easier to see the contact pins 42 are centered on the alignment indicators 36a, 36b. If it is determined that the contact pins 42 are not aligned with the contact pads 26, the method proceeds to step 110 and the position of the contact pins is adjusted. The contact pin position can be adjusted in any suitable manner. The techniques for adjusting the position of contact pins on a chip programming head are generally known in the art. For example, the orientation of the chip programming head 40 can be adjusted which adjusts the position of the contact pins. In another embodiment, the position of the contact pins can be adjusted relative to the chip programming head which remains fixed. The contact pin position can be adjusted manually by the user or adjusted automatically using a predetermined program of the controller. After adjusting the contact pin position, the method 100 may return to step 108 to again determine if the contact pins are aligned with the contact pads 26. Alternatively, if the chip programming head is retracted prior to adjusting the contact pin position, the method 100 may return to step 106 to bring the chip programming head and the alignment substrate toward one another again, and then execute step 108 to determine if the contact pins are aligned with the contact pads 26.

In step 108, if it is determined that the contact pins are aligned with the contact pads, the method 100 proceeds to step 112. In step 112, the chip programming head is retracted, and the alignment substrate 10 is removed from underneath the chip programming head. For example, the alignment substrate 10 may be manually removed by the user or mechanically removed by transporting the alignment substrate to a suitable location, for example to the card output 54. In addition, in step 112, and referring to FIGS. 3-4, 5A, 5B and 6, a card 80 having a chip 88 to be programmed is transported into the chip programmer 56 and positioned at the programming position relative to the chip programming head. The contact pins of the chip programming head are then brought into engagement with the contact pads 90 connected to the chip 88 and the chip 88 is programmed. One or more additional chips on one or more additional cards may also be programmed in sequence after the initial card is programmed.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An alignment card comprising:
a card-shaped substrate having a first surface, a second surface opposite the first surface, and a perimeter edge;
a test chip on the card-shaped substrate, the test chip is connected to contact pads that are exposed at the first surface; and
alignment indicators on the first surface, the alignment indicators intersect the contact pads.

2. The alignment card of claim 1, wherein the test chip is programmable, and the contact pads are electrical contacts that are electrically connected to the test chip.

3. The alignment card of claim 1, wherein the perimeter edge includes first and second side edges, and first and second end edges;
the alignment indicators comprise vertical alignment indicators and horizontal alignment indicators, the vertical alignment indicators are parallel to the first and second end edges, and the horizontal alignment indicators are parallel to the first and second side edges.

4. The alignment card of claim 3, wherein the vertical alignment indicators extend from the first side edge and extend from the second side edge.

5. The alignment card of claim 3, wherein the horizontal alignment indicators extend from the first end edge and extend from the second end edge.

6. The alignment card of claim 3, wherein the vertical alignment indicators comprise alignment lines that are visible to the naked eye, and wherein the horizontal alignment indicators comprise alignment lines that are visible to the naked eye.

7. The alignment card of claim 1, wherein the card-shaped substrate is 85.60 mm by 53.98 mm with rounded corners.

8. A method comprising using the alignment card of claim 1 to align contact pins of a chip programming head.

9. An alignment substrate comprising:
a substrate having a first surface, a second surface opposite the first surface, first and second side edges, and first and second end edges;
a programmable test chip on the substrate, the programmable test chip is electrically connected to electrical contact pads that are exposed at the first surface; and
alignment lines on the first surface, the alignment lines are visible to the naked eye and intersect the electrical contact pads.

10. The alignment substrate of claim 9, wherein the alignment lines comprise vertical alignment lines and horizontal alignment lines, the vertical alignment lines are parallel to the first and second end edges, and the horizontal alignment lines are parallel to the first and second side edges.

11. The alignment substrate of claim 10, wherein the vertical alignment lines extend from the first side edge and extend from the second side edge.

12. The alignment substrate of claim 10, wherein the horizontal alignment lines extend from the first end edge and extend from the second end edge.

13. The alignment substrate of claim 9, wherein the substrate is 85.60 mm by 53.98 mm with rounded corners.

14. A method comprising using the alignment substrate of claim 9 to align contact pins of a chip programming head.

15. A method of aligning contact pins of a chip programming head for programming a programmable chip on a card, comprising:
positioning an alignment substrate under the chip programming head; the alignment substrate having a first surface, a second surface opposite the first surface, first and second side edges, first and second end edges, a programmable test chip that is electrically connected to electrical contact pads that are exposed at the first surface, and alignment lines on the first surface that are visible to the naked eye and intersect the electrical contact pads;
bringing the chip programming head and the alignment substrate toward each other until the contact pins are near or in contact with the electrical contact pads;
determining whether the contact pins are aligned with the electrical contact pads;
if the contact pins are not aligned with the electrical contact pads, adjusting the position of the contact pins until the contact pins are aligned with the electrical contact pads; and
removing the alignment substrate and transporting the card to a position under the chip programming head and thereafter using the contact pins of the chip programming head to communicate with the programmable chip on the card.

16. The method of claim 15, wherein using the contact pins of the chip programming head to communicate with the programmable chip on the card comprises resetting the programmable chip or programming the programmable chip.

17. An alignment card comprising a card-shaped substrate having a first surface, a second surface opposite the first surface, and a perimeter edge; a programmable test chip on the card-shaped substrate, the programmable test chip is electrically connected to electrical contact pads that are exposed on the card-shaped substrate.

18. The alignment card of claim 17, further comprising alignment indicators on the card-shaped substrate adjacent to the electrical contact pads.
